(19) United States
(12) Patent Application Publication
(10) Pub. No.: US 2004/0204202 A1
(43) Pub. Date: Oct. 14, 2004

(54) Mobile phone

(75) Inventors: Masaki Shimamura, Tokyo (JP); Mitio Nagai, Tokyo (JP); Mika Fujii, Tokyo (JP); Kazuo Ootsuta, Tokyo (JP); Kiyosi Kohayakawa, Tokyo (JP); Masatomo Mizuta, Tokyo (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/391,214

(22) Filed: Mar. 18, 2003

(30) Foreign Application Priority Data
Mar. 27, 2002 (JP) 089656/2002

(51) Int. Cl. H04B 1/38

(52) U.S. Cl. 455/575.1; 455/90.3

(57) ABSTRACT

A housing improves the operability of a mobile phone in a sliding structure. With the mobile phone having the front unit and the back unit in the shortened state, a phone book can be searched with the phone number information about the partner, icon information, etc. displayed on the display portion, and the mobile phone enters the expansion state. In the control portion, when the expansion detecting portion detects the change from the shortened state to the expansion state according to the output signal of the magnetic sensor, the display contents on the display portion are determined, and it is determined whether or not the phone number information or the information relating to the phone number information (for example, an image, an icon, the phone book information such as a name, etc.) is displayed on the display portion. If the phone number information or the information relating to the phone number information is displayed, then an automatic call issuing process is performed through the circuit control portion according to the phone number information.

### BACKGROUND OF THE INVENTION

1. Field of the Invention

The present invention relates to a mobile phone, and more specifically to a mobile phone having a housing of a sliding structure in which a front unit and a back unit are coupled for preferable use in, for example, reducing the frequency of dialing operations.

2. Description of the Prior Art

A mobile phone is configured by two units to satisfy the requests for a straight type housing and a smaller unit, and the two units are coupled by a coupling member in a folding structure or a sliding structure. A housing in the sliding structure is configured by a primary housing (first unit) with a mobile housing (second unit) including a part of functional portions coupled to the primary housing with free slide in the major axis direction. The mobile phone is carried with the two units overlaying each other in a shortened state.

The mobile phone of this type is expanded such that the two units are separated in the major axis direction when a telephone conversation is started, and a dialing operation is performed in a predetermined procedure. In this case, after a power switch is turned on, it is confirmed that a start key is pressed and a telephone conversation can be started, and the phone number of a partner is input using ten keys. Then, a dialing operation is automatically performed, and a call is issued to the phone number of the partner. When automatic dialing operation is performed, the phone number of a partner is stored in advance in memory, the phone number of the partner is read from the memory by pressing a call key when a telephone conversation is started, and a start key is pressed, thereby automatically starting the dialing operation. Similarly, a connection is made to a predetermined Web server, and the activation of generation of electronic mail can be performed in the respective predetermined operations.

However, there has been the following problem with the above mentioned conventional technology.

That is, in issuing a call to a predetermined phone number, connecting a call to a predetermined Web server, activating the generation of electronic mail, etc., it is necessary for a user to perform a predetermined operation after setting his or her mobile phone in an expansion state. Therefore, the user feels the trouble of performing each operation.

### BRIEF SUMMARY OF THE INVENTION

The present invention has been developed to solve the above mentioned problems, and aims at providing a mobile phone for improving the operability and convenience in a sliding structure.

To solve the above mentioned problems, the invention according to claim 1 is a mobile phone having a front unit, a back unit coupled to a back of the front unit with free slide in a major axis direction, and an inset releasing unit, provided on one side of the front unit or the back unit, for releasing an inset state of the front unit in relation to the back unit, including: expansion detection means for generating an expansion detection signal when the inset releasing unit is operated to change a shortened state of the front unit and the back unit into an expansion state, and the expansion state is detected; and control means for issuing a call to a predetermined phone number, connecting to a predetermined Web server, or activating the generation of electronic mail when the expansion detection signal is generated.

The invention according to claim 2 is a mobile phone having a front unit including a display portion and a receiver portion, a back unit which has a master console portion and is coupled to a back of the front unit with free slide in a major axis direction, and an inset releasing unit, provided on one side of the front unit or the back unit, for releasing an inset state of the front unit in relation to the back unit, including: expansion detection means for generating an expansion detection signal when the inset releasing unit is operated to change a shortened state of the front unit and the back unit into an expansion state, and the expansion state is detected; and control means for issuing a call to a predetermined phone number, connecting a call to a predetermined Web server, or activating the generation of electronic mail depending on display contents of the display portion of the front unit when the expansion detection signal is generated.

The invention according to claim 3 is based on the mobile phone according to claim 2. The control means issues a call to a phone number corresponding to phone book information being displayed by the display portion of the front unit when the inset releasing unit is operated to change a shortened state of the front unit and the back unit into an expansion state while the phone book information is being displayed.

The invention according to claim 4 is based on the mobile phone according to claim 2. The control means makes a connection to a URL (uniform resource locator) corresponding to URL information being displayed by the display portion of the front unit when the inset releasing unit is operated to change a shortened state of the front unit and the back unit into an expansion state while the URL information is being displayed.

The invention according to claim 5 is based on the mobile phone according to claim 2. The control means activates the generation of electronic mail addressed to a message source corresponding to message information being displayed, or the generation of electronic mail referring to the message information being displayed when the inset releasing unit is operated to change the shortened state of the front unit and the back unit into the expansion state while the message information is being displayed.

The invention according to claim 6 is based on the mobile phone according to claim 1 further including clock means for generating time information. With the configuration, the control means includes a time determining portion for issuing a call to a predetermined phone number, connecting a call to a predetermined Web server, or activating the generation of electronic mail according to the time information when the expansion detection signal is generated.

The invention according to claim 7 is based on the mobile phone according to claim 1 further including lean detection means for detecting a lean of the phone against a vertical line and generating lean information. With the configuration, the control means includes a lean determination portion for issuing a call to a predetermined phone number, connecting a call to a predetermined Web server, or activating the generation of electronic mail according to the lean information when the expansion detection signal is generated.

The invention according to claim 8 is based on the mobile phone according to claim 1 further including position detection means for detecting a position of the phone and generating position information. With the configuration, the control means includes a position determination portion for issuing a call to a predetermined phone number, connecting a call to a predetermined Web server, or activating the generation of electronic mail according to the position information when the expansion detection signal is generated.

The invention according to claim 9 is based on the mobile phone according to claim 1. The control means issues a call to a predetermined phone number, connects a call to a predetermined Web server, or activates the generation of electronic mail according to externally obtained position information about the phone when the expansion detection signal is generated.

The invention according to claim 10 is based on the mobile phone according to claim 1 further including an expandable antenna portion. With the configuration, the control means includes an antenna control portion for setting the antenna portion in an expansion state when the expansion detection signal is generated.

The invention according to claim 11 is based on the mobile phone according to claim 1 further including image pickup means for generating a video signal around the phone. With the configuration, the control means issues a call to a predetermined phone number, makes a connection to a predetermined Web server, and transmits the video signal when the expansion detection signal is generated.

The invention according to claim 12 is a mobile phone having a front unit, a back unit coupled to a back of the front unit with free slide in a major axis direction, and an inset releasing unit, provided on one side of the front unit or the back unit, for releasing an inset state of the front unit in relation to the back unit, including: expansion detection means for generating an expansion detection signal when the inset releasing unit is operated to change a shortened state of the front unit and the back unit into an expansion state, and the expansion state is detected; and control means for performing an operation arbitrarily set by a user when the expansion detection signal is generated.

### BRIEF DESCRIPTION OF THE DRAWINGS

FIGS. 1A and 1B show the appearance of the mobile phone in a shortened state according to the first embodiment of the present invention;

FIGS. 2A to 2C show the appearance of the mobile phone shown in FIG. 1 in an expansion state;

FIG. 3 is a block diagram of the electric configuration in a front unit 10 and a back unit 20;

FIGS. 4A to 4C show the information displayed on a display portion 11;

FIGS. 5A to 5D show the information displayed on the display portion 11;

FIGS. 6A to 6B show the information displayed on the display portion 11;

FIGS. 7A to 7C show the appearance of the mobile phone in an expansion state according to the second embodiment of the present invention;

FIGS. 8A to 8C show the appearance of the mobile phone in an expansion state according to the third embodiment of the present invention;

FIGS. 9A and 9B show the appearance of the mobile phone shown in FIG. 8 in a shortened state; and

FIGS. 10A to 10D show the appearance of the mobile phone in an expansion state according to the fourth embodiment of the present invention.

### DETAILED DESCRIPTION OF THE PREFERRED EMBODIMENTS

The preferred embodiments of the present invention are described below in detail by referring to the attached drawings.

First Embodiment

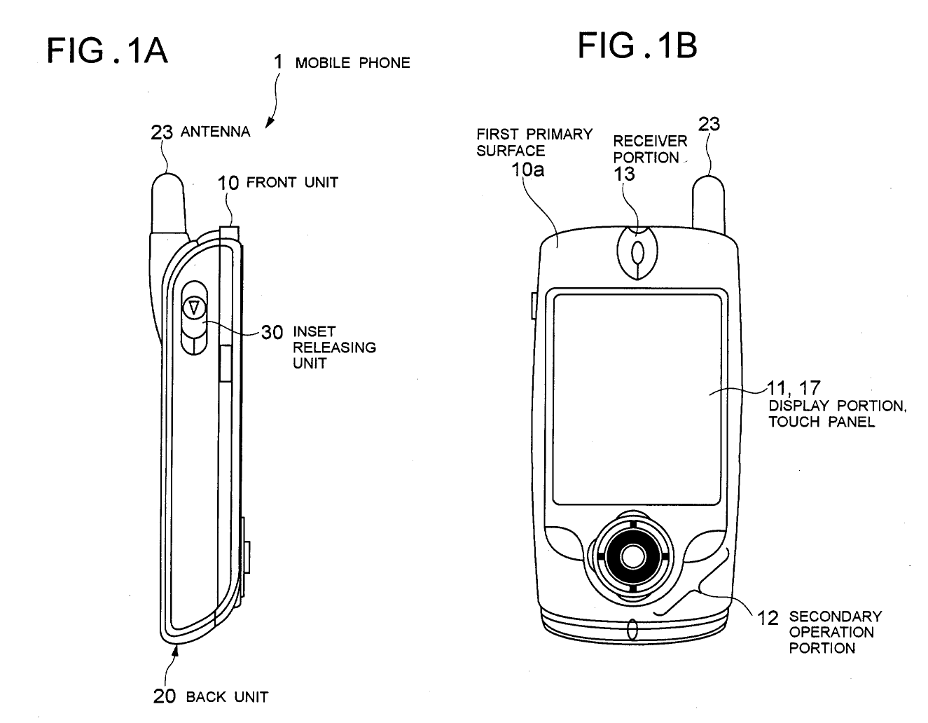

FIGS. 1A and 1B show the appearance of the mobile phone 1 in the shortened state according to the first embodiment of the present invention. FIG. 1A is a side view, and FIG. 1B is a front view.

As shown in FIG. 1A, a mobile phone 1 according to the present embodiment is configured by a front unit 10 and a back unit 20. The back unit 20 is provided with an antenna 23, and is coupled to the back of the front unit 10 with free slide in the major axis direction. Provided on one side of the back unit 20 is an inset releasing unit (for example, a one touch slide button) 30 for releasing the inset state of the front unit 10 in relation to the back unit 20. As shown in FIG. 1B, the front unit 10 comprises a first primary surface 10a comprising a display portion 11, a secondary operating portion 12, and a receiver portion 13. The display portion 11 has a touch panel 17 incorporated into it.

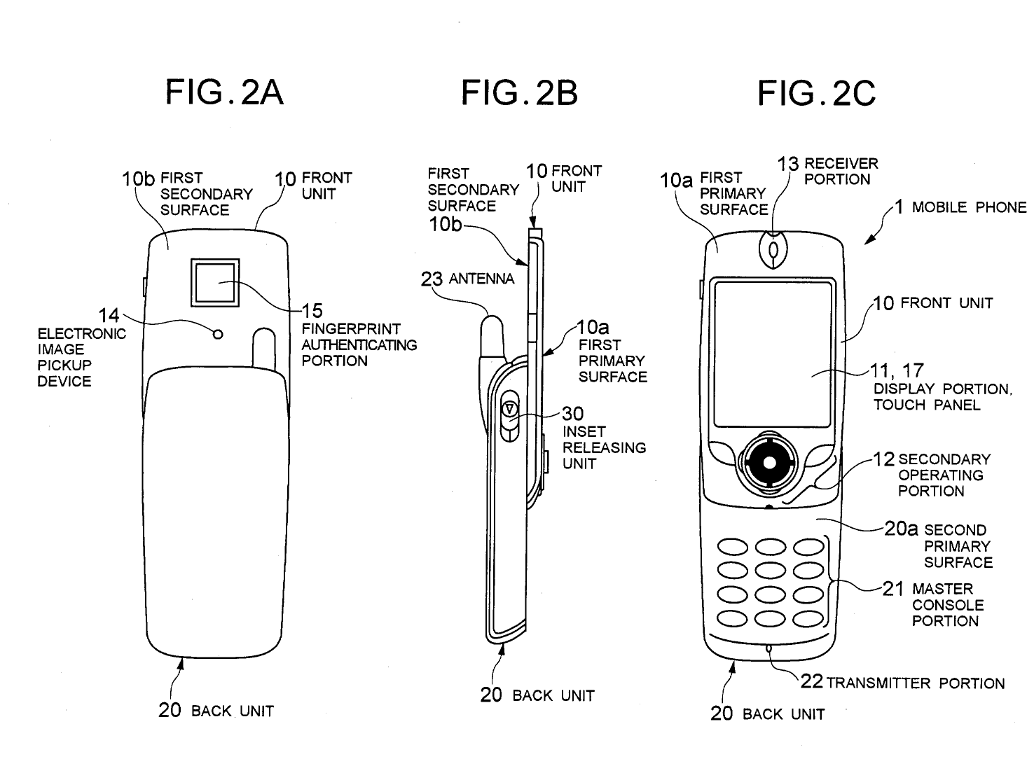

FIGS. 2A, 2B, and 2C show the appearance of the mobile phone shown in FIG. 1 in the expansion state. FIG. 2A is a back view, FIG. 2B is a side view, and FIG. 2C is a front view.

As shown in FIG. 2A, the front unit 10 comprises a first secondary surface 10b on its back comprising an electronic image pickup device (for example, a CCD camera) 14, and an optical aperture (for example, a sensor portion) of a fingerprint authenticating portion 15. Additionally, a magnet not shown in the attached drawings is provided at an appropriate position on the first secondary surface 10b. The back unit 20 is also provided with a magnetic sensor such as a Hall device, etc. not shown in the attached drawings as opposite the magnet in the shortened state.

Furthermore, as shown in FIG. 2B, the front unit 10 and the back unit 20 are attached by attaching means not shown in the attached drawings but provided inside the mobile phone 1 in an expansion state in the major axis direction. Insetting means (for example, a lock system) is provided for insetting the front unit 10 and the back unit 20 on the attaching means in the state of the front unit 10 and the back unit 20 overlaying each other (that is, in the shortened state). The inset state by the insetting means can be released by operating the inset releasing unit 30.

The back unit 20 further comprises, as shown in FIG. 2C, a second primary surface 20a comprising a master console portion 21 and a transmitter portion (microphone) 22. The back unit 20 contains an electric circuit such as a control portion not shown in the attached drawings.

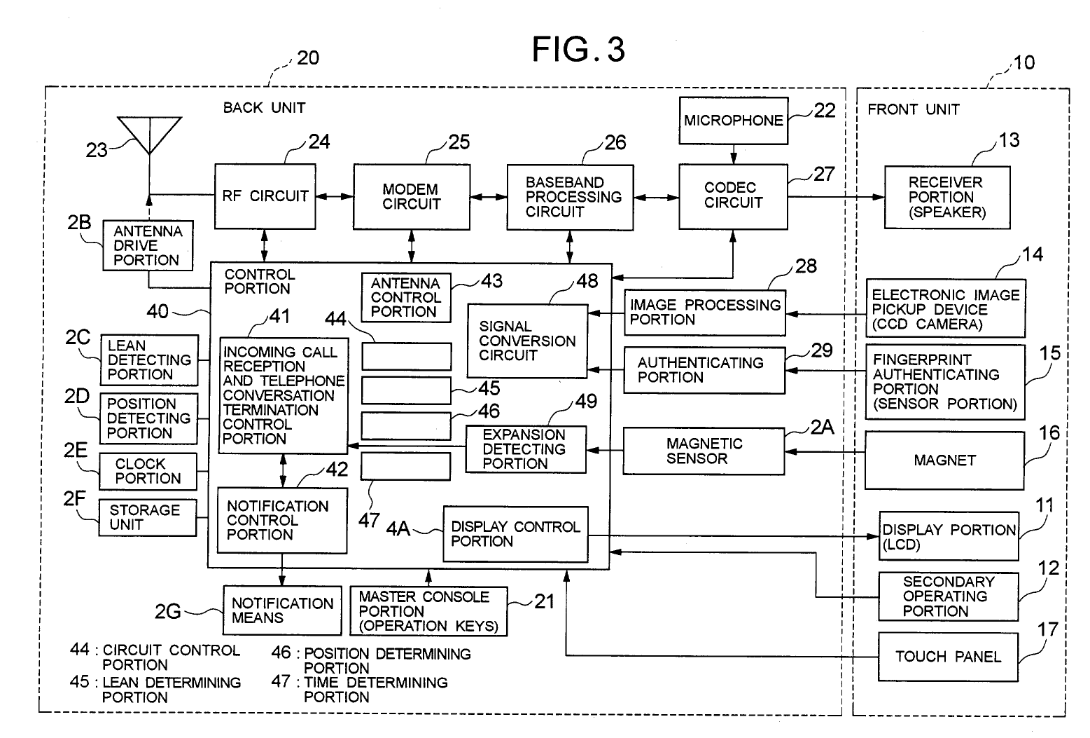

FIG. 3 is a block diagram of the electric configurations in the front unit 10 and the back unit 20.

The front unit 10 contains the display portion (for example, an LCD (liquid crystal display)) 11, the secondary operating portion (for example, a secondary operation key) 12, the receiver portion (for example, a speaker) 13, the electronic image pickup device (for example, a CCD camera) 14, the fingerprint authenticating portion 15, the magnet 16 for detecting the relative position (that is, the expansion state) between the front unit 10 and the back unit 20, and the touch panel 17.

The display portion 11 displays, for example, various information such as the phone number information about partners, icon information, etc. The secondary operating portion 12 allows a user to visually recognize the displayed contents on the display portion 11 in the shortened state of the front unit 10 and the back unit 20, and performs operations such as electronic mail processing, image processing, incoming call processing, etc. The receiver portion 13 generates audio corresponding to various information. The electronic image pickup device 14 generates a video signal by fetching the video surrounding the phone. The fingerprint authenticating portion 15 generates an image signal by recognizing the fingerprint of the user. The magnet 16 detects the relative position (that is, the expansion state) between the front unit 10 and the back unit 20. The touch panel 17 is embedded in the surface of the display portion 11, and detects the contents of the operation by the finger of the user.

The back unit 20 contains the master console portion (for example, an operation key) 21, the microphone 22, the antenna 23, an RF circuit 24, a modem circuit 25, a baseband processing circuit 26, a CODEC circuit 27, an image processing portion 28, an authenticating portion 29, a magnetic sensor (for example, a Hall device) 2A, an antenna drive portion 2B, a lean detecting portion 2C, a position detecting portion 2D, a clock portion 2E, a storage unit 2F, a notification means 2G, and a control portion 40.

The master console portion 21 is formed by a transmission key, an alphabet/kana (Japanese syllabary)/kanji (Chinese character)/numeric conversion key, a power on/off key, a cross key for cursor operation, and a termination key, etc. A microphone 22 receives user voice and transmits it. The antenna 23 receives and transmits electric waves to and from a radio base station not shown in the attached drawings. The RF circuit 24 comprises a reception circuit, a transmission circuit, and a frequency synthesizer not shown in the attached drawings. The modem circuit 25 demodulates received electric waves, and modulates transmission electric waves. The baseband processing circuit 26 retrieves the original baseband signal from the demodulation signal output from the modem circuit 25, and transmits it to the CODEC circuit 27. Furthermore, the baseband processing circuit 26 retrieves the character data from the demodulation signal output from the modern circuit 25, and transmits it to the control portion 40. The CODEC circuit 27 digital-to-analog converts the baseband signal output from the baseband processing circuit 26, transmits it to the receiver portion 13, and digital-to-analog converts the output signal from the control portion 40.

The image processing portion 28 fetches a video signal output from the electronic image pickup device 14, amplifies it into a predetermined signal level, analog-to-digital converts the amplified video signal, and performs image processing (for example, gamma correction, white-balance adjustment, etc.) on the signal. The authenticating portion 29 fetches an image signal output from the fingerprint authenticating portion 15, performs predetermined image processing (for example, magnification, reduction, emphasis of fingerprint discrimination point, etc.) on the signal, and detects the feature point used in fingerprint collation. The feature point can be a point at which the ridgeline (peak portion of a fingerprint pattern) ends (end point) and a point at which the ridgeline branches (branch point) which are collectively referred to as a feature point.

When the front unit 10 and the back unit 20 are in the shortened state, the magnetic sensor 2A generates a predetermined output signal by the magnetic field of the magnet 16, and detects the shortened state. The antenna drive portion 2B drives the antenna 23 for expansion and shortening. The lean detecting portion 2C is configured by a mover not shown in the attached drawings and a sensor for detecting the movement of the mover, etc. according to the lean of the mobile telephone 1, detects the lean of the mobile phone 1, and generates lean information. The position detecting portion 2D is configured by a GPS (global positioning system) receiver, receives beams emitted by three or more satellites located in the space, and measures the distance between each of the satellites and the phone based on the propagation speed and the propagation time of each beam, thereby measuring the position of the phone using at least the latitude and the longitude and generating the position information. The clock portion 2E generates time information (year, month, day, day of the week, hour/minute/second, etc.). The storage unit 2F stores, for example, phonebook information. The notification means 2G is configured by, for example, a speaker, a vibrator, a light-emitting diode, etc., and notifies that the front unit 10 and the back unit 20 enter the shortened state or the expansion state.

The control portion 40 comprises an incoming call reception and telephone conversation termination control portion 41, a notification control portion 42, an antenna control portion 43, a circuit control portion 44, a lean determining portion 45, a position determining portion 46, a time determining portion 47, a signal conversion circuit 48, an expansion detecting portion 49, and a display control portion 4A, and controls the entire mobile phone 1. The incoming call reception and telephone conversation termination control portion 41 performs an incoming call controlling operation depending on the shortened/expansion state between the front unit 10 and the back unit 20. The notification control portion 42 performs an incoming call reception time notifying operation depending on the shortened/expansion state between the front unit 10 and the back unit 20 by controlling the notification means 2G. For example, when the front unit 10 and the back unit 20 enter the shortened state, the notification control portion 42 controls the notification means 2G to make a vibration only, light-emission only, or a vibration and light-emission. When the front unit 10 and the back unit 20 enter the expansion state, the notification control portion 42 controls the notification means 2G to make a beep and light-emission.

The antenna control portion 43 controls the antenna drive portion 2B to expand the antenna 23 (expandable antenna, for example, a whip antenna) or performs expansion/shortened driving control. When an expansion detection signal is issued from the expansion detecting portion 49, the circuit control portion 44 performs the processes of issuing a call to a predetermined phone number, and connecting a call to a predetermined Web server depending on the display contents of the display portion 11 of the front unit. The lean determining portion 45 determines the lean of the mobile phone 1 according to the lean information output from the lean detecting portion 2C. The position determining portion 46 determines the current position of the mobile phone 1 according to the position information output from the position detecting portion 2D. The time determining portion 47 determines the year, month, day, day of the week, time according to the time information output from the clock portion 2E.

The signal conversion circuit 48 converts the video signal output from the image processing portion 28 into a predetermined format (for example, the JPEG system). The signal conversion circuit 48 also converts an image signal having a feature point output from the authenticating portion 29 into the format of the fingerprint collation process (for example, the coordinates of each feature point, the pattern direction, the number of intersections of ridgelines between the vicinal feature points, the pattern direction deviation, etc.). The expansion detecting portion 49 determines the shortened/expansion state between the front unit 10 and the back unit 20 according to the output signal of the magnetic sensor 2A, and issues an expansion detection signal when the units change from the shortened state to the expansion state. The display control portion 4A generates character information and graphics information for display on the display portion 11 based on the received data provided from the baseband processing circuit 26, and displays the information on the display portion 11.

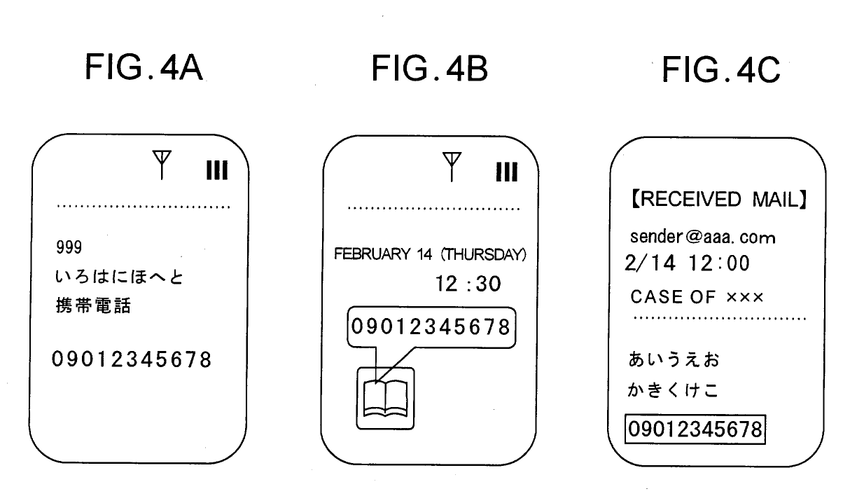

FIGS. 4, 5, and 6 show the information displayed on the display portion 11.

The operations of the mobile phone with the configuration shown in these figures are described below.

When the front unit 10 and the back unit 20 of the mobile phone 1 overlay each other in the shortened state, the front unit 10 can slide upward the back unit 20 into the expansion state by sliding the inset releasing unit 30. Thus, the master console portion 21 appears with the appropriate distance between the microphone 22 and the receiver portion 13, thereby enabling various operations and telephone conversation. With the above mentioned mobile phone 1, the secondary operating portion 12 is provided on the first primary surface 10a of the front unit 10. Therefore, the electronic mail processing operation, image processing operation, incoming call processing operation, etc. can be performed while checking the display contents on the display portion 11 with the front unit 10 and the back unit 20 overlaying each other.

Described below are the processes of issuing a call to a predetermined phone number, connecting a call to a predetermined Web server, and activating the generation of electronic mail performed when the front unit 10 and the back unit 20 are changed from the shortened state to the expansion state by operating the inset releasing unit 30.

(1) Process of Issuing a Call to a Predetermined Phone Number

With the mobile phone 1 having the front unit 10 and the back unit 20 in the shortened state, a phone book can be searched with the phone number information about the partner, icon information, etc. displayed on the display portion 11, and the mobile phone 1 enters the expansion state (that is, in the telephone conversation state) by operating the inset releasing unit 30. For example, the phone book information (phone number) is displayed on the display portion 11 in FIG. 4A, the phone number is recorded as an icon and the icon is focused (selected) on the display portion 11 in FIG. 4B, and the phone number in the text of the received mail displayed on the display portion 11 is focused (selected) on the display portion 11 in FIG. 4C.

In the control portion 40, when the expansion detecting portion 49 detects the change from the shortened state to the expansion state, that is, to the telephone conversation position, according to the output signal of the magnetic sensor 2A, the display contents on the display portion 11 are determined, and it is determined whether or not the phone number information or the information relating to the phone number information (for example, an image, an icon, the phone book information such as a name, etc.) is displayed on the display portion 11. If the phone number information or the information relating to the phone number information is displayed, then an automatic call issuing process is performed through the circuit control portion 44 according to the phone book information. When the displayed information refers to a plurality of phone numbers, the display can be set in advance such that one of them can be arbitrarily selected.

(2) Process of Connecting a Call to a Predetermined Web Server

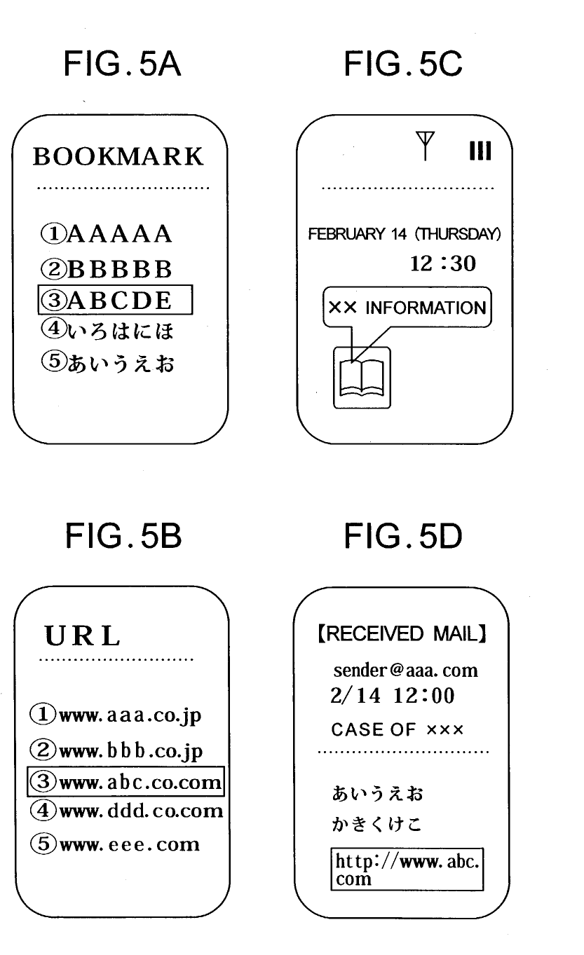

It is assumed that the mobile phone 1 is set in the shortened state, bookmark information, URL information, or the information relating to the URL information are displayed on the display portion 11, and the mobile phone 1 enters the expansion state (that is, in the telephone conversation position) by operating the inset releasing unit 30. For example, an arbitrary bookmark in the bookmarks (recorded) displayed on the display portion 11 is focused (selected) in FIG. 5A, an arbitrary URL in the URLs (history) displayed on the display portion 11 is focused (selected) in FIG. 5B, the URL is recorded as an icon and the icon is focused (selected) on the display portion 11 in FIG. 5C, and the URL in the text of the received mail displayed on the display portion 11 is focused (selected) in FIG. 5D.

In the control portion 40, when the expansion detecting portion 49 detects the change from the shortened state to the expansion state according to the output signal of the magnetic sensor 2A, the Web connection (automatic connection to a predetermined Web server) process is performed through the circuit control portion 44 according to the bookmark information, the URL information, or the information relating to the URL information. If the displayed information refers to plural pieces of Web page information, then the display can be set in advance such that an arbitrary information can be selected.

(3) Process of Activating the Generation of Electronic Mail

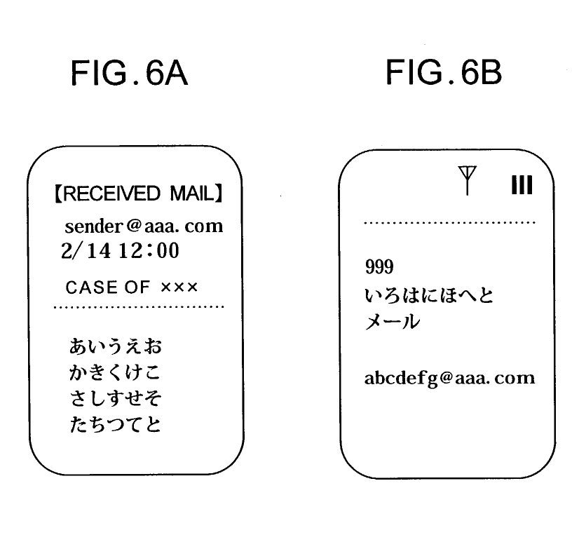

It is assumed that the display portion 11 of the mobile phone 1 set in the shortened state displays (specifies) the information such as a mail address, mail reception, etc., and the mobile phone 1 enters the expansion state (that is, the telephone conversation position) by operating the inset releasing unit 30. For example, mail reception (sender@aaa.com) is displayed in FIG. 6A, and the phone book information (mail address) is displayed in FIG. 6B. In the control portion 40, when the expansion detecting portion 49 detects the change from the shortened state to the expansion state according to the output signal of the magnetic sensor 2A, a mail generation screen according to the information such as the mail address, the mail reception, etc., that is, the mail generating process using a predetermined mail address as a destination (receiver) is activated. When displayed information refers to a plurality of mail addresses, the display can be set in advance such that an arbitrary mail address can be selected.

Since the clock portion 2E counts the time such as year, month, day, day of the week, hour/minute/second, etc., the automatic call issuing process, the automatic Web connecting process, the electronic mail generation activating process, etc. can be performed depending on the year, month, day, day of the week, hour/minute/second, etc. by changing the mobile phone in the shortened state into the expansion state by operating the inset releasing unit 30 after specifying in advance a specific time period and a process in the specific time period. That is, if a time period (for example, after 9:00 on weekdays) and a process (for example, issuing a call to home) are specified in advance, a call issuing process and a Web connection process can be performed by only one operation (of inset releasing unit), thereby improving the user convenience and operability.

Furthermore, the lean detecting portion 2C detects the lean of the mobile phone 1 against a vertical line, and the process can be selected depending on the lean. Therefore, if a process is specified in advance, for example, a call issuing process when the mobile phone 1 is almost vertical, a Web connection process when the mobile phone 1 is almost horizontal, etc., then an automatic call issuing process, an automatic Web connecting process, an electronic mail generation activating process, etc. can be performed depending on the lean of the body when the inset releasing unit 30 is operated. That is, although the displayed information includes plural pieces such as a phone number, a mail address, a Web page, etc., an arbitrary piece can be selected depending on the lean of the mobile phone 1, thereby improving the user convenience and operability.

The position detecting portion 2D detects the current position of the mobile phone 1. If a process in the same position as the specific position is specified in advance, then the automatic call issuing process, the automatic Web connecting process, the electronic mail generation activating process, etc. can be performed depending on the position by changing the mobile phone 1 in the shortened state into the expansion state by operating the inset releasing unit 30, thereby improving the user convenience and operability. The position information is not only generated by the position detecting portion 2D, but also externally received as the position information. In this case, the electric waves received by the position detecting portion 2D configured by a GPS receiver are transmitted to the radio base station, and the radio base station analyzes the electric waves and generates the position information about the mobile phone 1. The position information is transmitted to the mobile phone 1.

The antenna drive portion 2B controls the expansion of the expandable antenna 23. Therefore, when the mobile phone 1 is changed from the shortened state to the expansion state by operating the inset releasing unit 30 when the processes of issuing a call to a predetermined phone number, and connecting a call to a predetermined Web server are performed, the antenna 23 can be simultaneously expanded, thereby improving the user convenience and operability.

Furthermore, since the electronic image pickup device (CCD camera) 14 generates a video signal by fetching vicinal images surrounding the mobile phone 1, a video signal can be transmitted when the processes of issuing a call to a predetermined phone number, and connecting a call to a predetermined Web server are performed, and when the mobile phone 1 is changed from the shortened state to the expansion state by operating the inset releasing unit 30, thereby improving the user convenience and operability.

As described above, according to the first embodiment, the processes of issuing a call to a predetermined phone number, connecting a call to a predetermined Web server, and activating the generation of electronic mail are performed only by setting the mobile phone 1 from the shortened state to the expansion state by once operating the inset releasing unit 30 of the mobile phone 1, thereby improving the user convenience and operability.

Second Embodiment

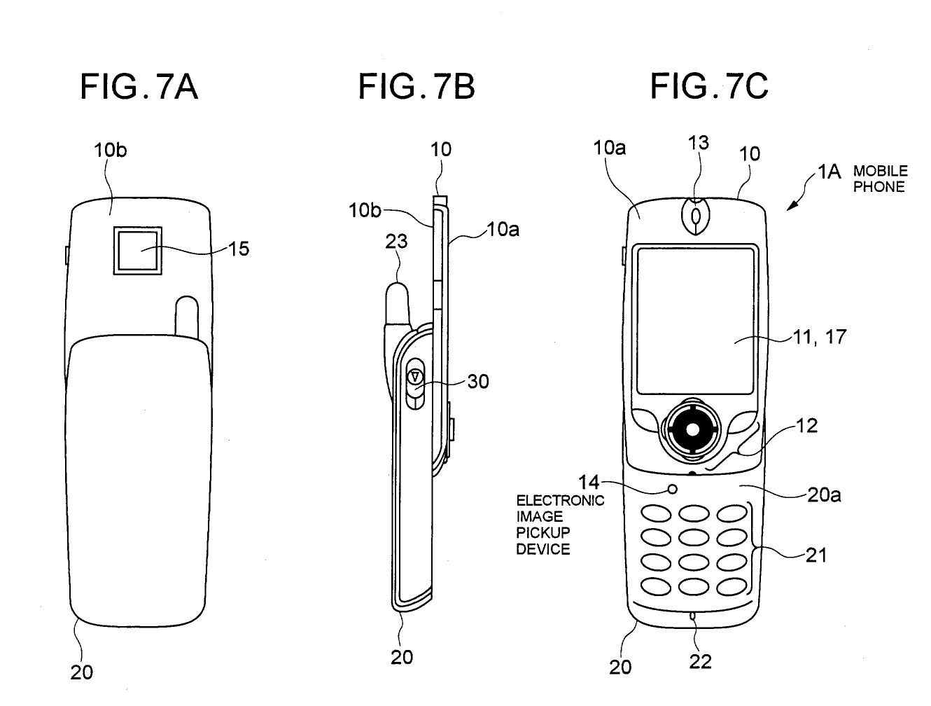

FIGS. 7A, 7B, and 7C show the appearance of the mobile phone in an expansion state according to the second embodiment of the present invention. FIG. 7A is a back view, FIG. 7B is a side view, and FIG.7C is a frontview. In these figures, the components also used according to the first embodiment as shown in FIG. 2 are assigned the same reference numerals.

A mobile phone 1A according to the present embodiment has the electronic image pickup device (CCD camera) 14 provided on the second primary surface 20a of the back unit 20 as shown in FIG. 7C. Otherwise, the configuration is the same as that shown in FIG. 2.

In the mobile phone 1A, the electronic image pickup device 14 is provided on the second primary surface 20a. Therefore, the mobile phone can be used in a television phone communication or a television phone conference, thereby improving the user convenience and operability.

Third Embodiment

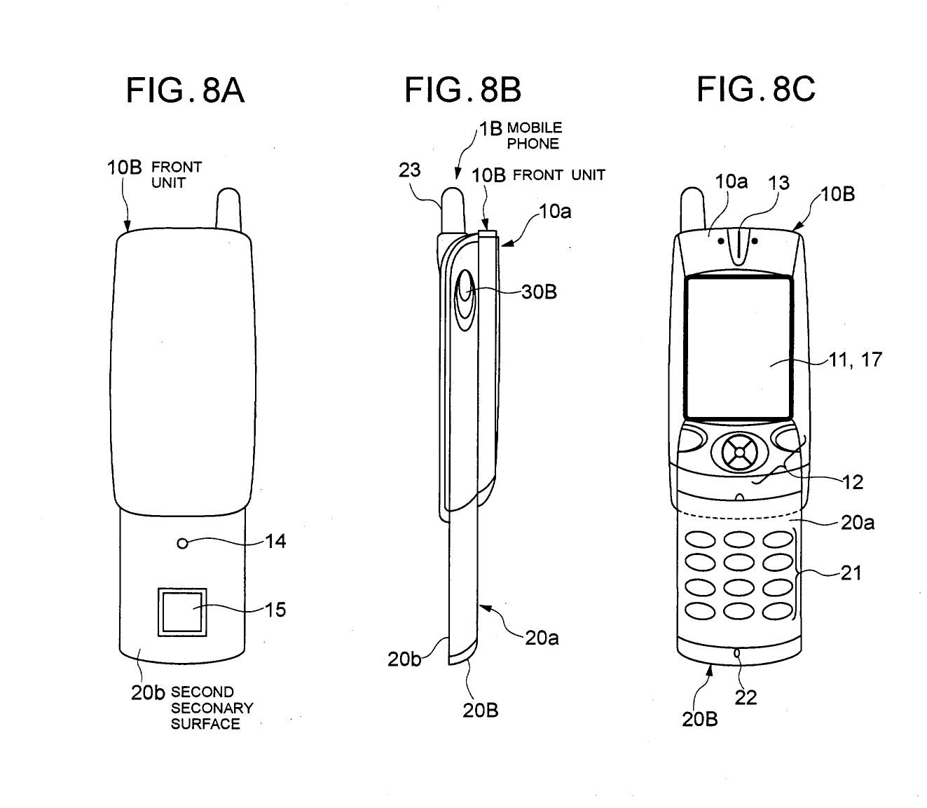

FIGS. 8A, 8B, and BC show the appearance of the mobile phone in an expansion state according to the third embodiment of the present invention. FIG. 8A is a back view, FIG. 8B is a side view, and FIG. 8C is a frontview. In these figures, the components also used according to the first embodiment as shown in FIG. 2 are assigned the same reference numerals.

In a mobile phone 1B according to the present embodiment, the front unit 10, the back unit 20, and the inset releasing unit 30 are replaced with a front unit 10B, a back unit 20B, and a inset releasing unit 30B having different shapes. The front unit 10B is formed as a hollow sheath open downward, a back unit 20B is contained in the front unit 10B, and coupled with free slide in the major axis direction. The inset releasing unit 30B is provided on one side of the front unit 10B. The electronic image pickup device 14 and the fingerprint authenticating portion 15 are provided on a second secondary surface 20b of the back unit 20B.

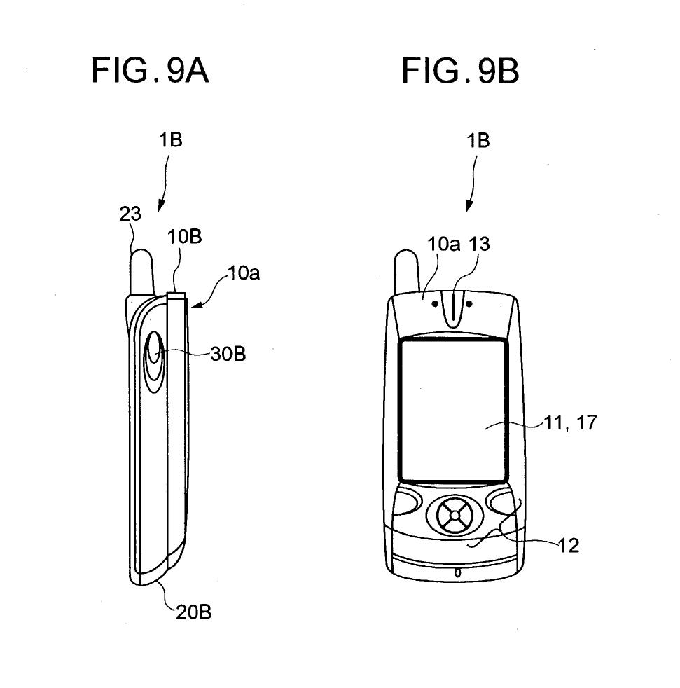

FIGS. 9A and 9B show the appearance of the mobile phone shown in FIG. 8 in a shortened state. FIG. 9A is a side view, and FIG. 9B is a front view.

As shown in FIG. 9, in the state in which the back unit 20B is contained in the front unit 10B (shortened state), the master console portion 21, the electronic image pickup device 14, and an optical aperture of the fingerprint authenticating portion 15 are covered with the back of the front unit 10B for protection.

The mobile phone 1B according to the present embodiment performs the operations similar to those according to the first embodiment, and has similar advantages.

Fourth Embodiment

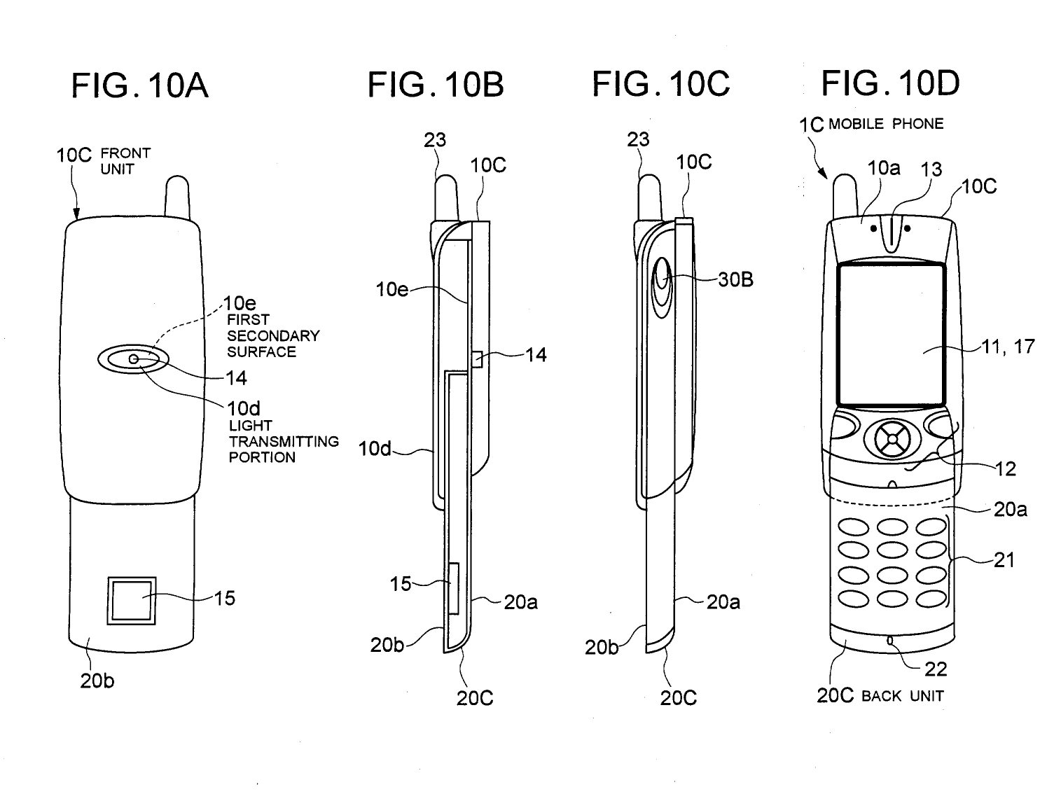

FIGS. 10A, 10B, 10C, and 10D show the appearance of the mobile phone in an expansion state according to the fourth embodiment of the present invention. FIG. 10A is a back view, FIG. 10B is a side sectional view, FIG. 10C is a side view, and FIG. 10D is a front view. In these figures, the components also used according to the third embodiment as shown in FIG. 8 are assigned the same reference numerals.

In a mobile phone 1C according to the present embodiment, the front unit 10B and the back unit 20B shown in FIG. 8 are replaced with a front unit 10C and a back unit 20C having different shapes. In the front unit 10C, the electronic image pickup device 14 is provided on a back surface (first secondary surface) 10e facing the internal space on the reverse of the first primary surface 10a. Furthermore, a light transmitting portion 10d is provided corresponding to the electronic image pickup device 14 on the back of the front unit 10C. The light transmitting portion 10d is a penetrating hole a little larger than the aperture of the electronic image pickup device 14. Otherwise, the configuration is similar to that shown in FIG. 8.

The mobile phone 1C according to the present embodiment performs similar operations to those according to the first embodiment of the present invention, and has similar advantages. Additionally, when the back unit 20C is drawn from the front unit 10C in the expansion state (in a use state), the external light enters from the aperture of the electronic image pickup device 14 through the light transmitting portion 10d and the image captured by the electronic image pickup device 14 is used in the communications. In the state (shortened state) in which the back unit 20C is contained in the front unit 10C, the aperture of the electronic image pickup device 14 is hidden by the back unit 20C for protection.

The embodiments of the present invention have been described above by referring to the attached drawings, but practical configurations are not limited to those. That is, any variation within the scope of the gist of the present invention is included in the present invention.

For example, in each embodiment, the inset releasing unit 30 is once operated to change the mobile phone from the shortened state to the expansion state so that the processes of issuing a call to a predetermined phone number, connecting a call to a predetermined Web server, and activating the generation of electronic mail can be performed. However, the user can perform an operation arbitrarily set in advance. Furthermore, at least a corresponding portion of the light transmitting portion 10d shown in FIG. 10 can be made of a transparent material, or a transparent protective plate can be used for the corresponding portion. Thus, an airtight structure can be obtained, thereby preventing the presence of foreign matters. Additionally, the magnet 16 and the magnetic sensor 2A can be configured by a switch which can be turned on/off depending on the expansion/shortened state between the front unit 10 and the back unit 20.

As described above, with the configuration of the present invention, the processes of issuing a call to a predetermined phone number, connecting a call to a predetermined Web server, and activating the generation of electronic mail are performed by once operating the inset releasing unit of the mobile phone in the shortened state into the expansion state, thereby improving the user convenience and operability. Additionally, when an expansion detection signal is issued, the processes of issuing a call to a predetermined phone number, connecting a call to a predetermined Web server, and activating the generation of electronic mail are performed according to time information, thereby improving the user convenience and operability. Furthermore, when an expansion detection signal is issued, the processes of issuing a call to a predetermined phone number, connecting a call to a predetermined Web server, and activating the generation of electronic mail are performed according to lean information, thereby improving the user convenience and operability.

Additionally, when an expansion detection signal is issued, the processes of issuing a call to a predetermined phone number, connecting a call to a predetermined Web server, and activating the generation of electronic mail are performed according to position information, thereby improving the user convenience and operability. Furthermore, when an expansion detection signal is issued, the processes of issuing a call to a predetermined phone number, connecting a call to a predetermined Web server, and activating the generation of electronic mail are performed according to externally input position information about the mobile phone, thereby improving the user convenience and operability. Additionally, when an expansion detection signal is issued, an antenna portion is set in the expansion state, thereby improving the user convenience and operability. Furthermore, when an expansion detection signal is issued, the processes of issuing a call to a predetermined phone number and connecting a call to a predetermined Web server are performed, and a video signal is transmitted, thereby improving the user convenience and operability. In addition, when an expansion detection signal is issued, an operation arbitrarily set in advance by a user is performed, thereby improving the user convenience and operability.

What is claimed is:

1. A mobile phone having a front unit, a back unit coupled to a back of the front unit with free slide in a major axis direction, and an inset releasing unit, provided on one side of the front unit or the back unit, for releasing an inset state of the front unit in relation to the back unit, comprising:
expansion detection means for generating an expansion detection signal when the inset releasing unit is operated to change a shortened state of the front unit and the back unit into an expansion state, and the expansion state is detected; and
control means for issuing a call to a predetermined phone number, connecting a call to a predetermined Web server, or activating generation of electronic mail when the expansion detection signal is generated.

2. A mobile phone having a front unit including a display portion and a receiver portion, a back unit which has a master console portion and is coupled to a back of the front unit with free slide in a major axis direction, and an inset releasing unit, provided on one side of the front unit or the back unit, for releasing an inset state of the front unit in relation to the back unit, comprising:
expansion detection means for generating an expansion detection signal when the inset releasing unit is operated to change a shortened state of the front unit and the back unit into an expansion state, and the expansion state is detected; and
control means for issuing a call to a predetermined phone number, connecting a call to a predetermined Web server, or activating generation of electronic mail depending on display contents of the display portion of the front unit when the expansion detection signal is generated.

3. The mobile phone according to claim 2, wherein
said control means issues a call to a phone number corresponding to phone book information being displayed by the display portion of the front unit when the inset releasing unit is operated to change a shortened state of the front unit and the back unit into an expansion state while the phone book information is being displayed.

4. The mobile phone according to claim 2, wherein
said control means makes a connection to a URL (uniform resource locator) corresponding to URL information being displayed by the display portion of the front unit when the inset releasing unit is operated to change a shortened state of the front unit and the back unit into an expansion state while the URL information is being displayed.

5. The mobile phone according to claim 2, wherein
said control means activates generation of electronic mail addressed to a message source corresponding to message information being displayed, or generation of electronic mail referring to the message information being displayed when the inset releasing unit is operated to change the shortened state of the front unit and the back unit into the expansion state while the message information is being displayed.

6. The mobile phone according to claim 1, further comprising
clock means for generating time information, wherein
said control means comprises a time determining portion for issuing a call to a predetermined phone number, connecting a call to a predetermined Web server, or activating generation of electronic mail according to the time information when the expansion detection signal is generated.

7. The mobile phone according to claim 1, further comprising
lean detection means for detecting a lean of the phone against a vertical line and generating lean information, wherein
said control means comprises a lean determination portion for issuing a call to a predetermined phone number, connecting a call to a predetermined Web server, or activating generation of electronic mail according to the lean information when the expansion detection signal is generated.

8. The mobile phone according to claim 1, further comprising
position detection means for detecting a position of the phone and generating position information, wherein
said control means comprises a position determination portion for issuing a call to a predetermined phone number, connecting a call to a predetermined Web server, or activating generation of electronic mail according to the position information when the expansion detection signal is generated.

9. The mobile phone according to claim 1, wherein
said control means issues a call to a predetermined phone number, connects a call to a predetermined Web server, or activates generation of electronic mail according to externally obtained position information about the phone when the expansion detection signal is generated.

10. The mobile phone according to claim 1, further comprising
an expandable antenna portion, wherein
said control means comprises an antenna control portion for setting said antenna portion in an expansion state when the expansion detection signal is generated.

11. The mobile phone according to claim 1, further comprising
image pickup means for generating a video signal around the phone, wherein
said control means issues a call to a predetermined phone number, makes a connection to a predetermined Web server, and transmits the video signal when the expansion detection signal is generated.

12. A mobile phone having a front unit, a back unit coupled to a back of the front unit with free slide in a major axis direction, and an inset releasing unit, provided on one side of the front unit or the back unit, for releasing an inset state of the front unit in relation to the back unit, comprising:
expansion detection means for generating an expansion detection signal when the inset releasing unit is operated to change a shortened state of the front unit and the back unit into an expansion state, and the expansion state is detected; and
control means for performing an operation arbitrarily set by a user when the expansion detection signal is generated.
